(19) United States
(12) Patent Application Publication
(10) Pub. No.: US 2010/0276853 A1
(43) Pub. Date: Nov. 4, 2010

(54) Anti-Vibration Device, Anti-Vibration System Comprising Such a Device and Method of Manufacture

(75) Inventors: Herve Visage, Chateaudun (FR); Pascal Petit, Beaugency (FR); Gilles Chenais, Marboue (FR); Patrick Loriot, Epernon (FR)

Correspondence Address: MILLER, MATTHIAS & HULL, ONE NORTH FRANKLIN STREET, SUITE 2350, CHICAGO, IL, 60606, US

(73) Assignee: Hutchinson, Paris (FR)

(21) Appl. No.: 12/432,475

(22) Filed: Apr. 29, 2009

(30) Foreign Application Priority Data
Apr. 29, 2009 (FR) 08 52900

(51) Int. Cl. F16M 5/00; B23P 11/00

(52) U.S. Cl. 267/140.4; 29/505

(57) ABSTRACT

An anti-vibration device is disclosed comprising an anti-vibration support comprising first and second rigid frames connected together by an elastomeric body and a limiting cap which is snap fitted onto the second frame and designed to be fastened onto a receiving member while clamping the second frame.

This invention relates to anti-vibration devices, to anti-vibration systems comprising such devices and to the methods of manufacture thereof.

More particularly, the invention relates to an anti-vibration device comprising:
an anti-vibration support comprising first and second rigid frames which are connected together by an elastomeric body designed to support a load in a first direction,
a limiting cap designed to be fastened onto a receiving member, said limiting cap being designed to limit the travel of the first frame at least in the first direction and in a second direction perpendicular to the first direction, the second frame being connected to the limiting cap by at least one mechanical connection designed to rigidly attach said second frame to the limiting cap, and the limiting cap is designed to be fastened onto the receiving member by clamping the second frame against said receiving member.

The document DE-B3-102 49 387 describes an anti-vibration device such as this, in which the second frame is a base plate which is connected to the limiting cap by crimped-on legs.

The purpose of this invention is to improve anti-vibration devices of this type, in particular in order to simplify the manufacturing processes thereof and to limit the cost thereof.

To that end, according to the invention, an anti-vibration device of the type in question is characterised in that the second frame is snap fitted onto the limiting cap in the first direction.

Owing to these arrangements, the engine mount can be pre-assembled to the limiting cap in an extremely simple manner, by nesting, and then, where appropriate, stored and transported as before the limiting cap is fastened onto the receiving member (e.g., a vehicle body portion). The aforementioned snap-on connection comprises a temporary attachment of the second frame to the limiting cap, the final assembly between the limiting cap and the anti-vibration support being obtained only during mounting of the limiting cap on the receiving member, after which the second frame is clamped between the limiting cap and said receiving member.

The initial manufacturing process for the anti-vibration device is thus simplified, without thereby complicating the final assembly thereof, which can take place, for example, when it is mounted on the vehicle.

In various embodiments of the anti-vibration device according to the invention, it is further possible to optionally make use of one or both of the following arrangements:
the anti-vibration support is a hydraulic support having a hydraulic system which is leak-proof and filled with a liquid, comprising:
a working chamber defined by the elastomeric body,
a compensation chamber defined by a flexible elastomeric wall integral with the second frame,
and a constricted passageway interconnecting the working chamber and the compensation chamber;
the second frame comprises at least one lateral lug inserted into a recess made in the limiting cap;
the second frame is made of a plastic material (the plastic material construction facilitates the snap-on connection);
the limiting cap has an upside-down U-shape, comprising at least one upper wall overlapping the first frame and two lateral wings arranged on both sides of the anti-vibration support and snapped onto the second frame (this U-shape ensures flexibility, thereby facilitating the snapping of the second frame onto the limiting cap);
the limiting cap further comprises two legs which extend the lateral wings opposite one another, said legs being provided with attachment means designed to be fastened onto said receiving member;
the legs of the limiting cap overlap lugs belonging to the second frame;
the legs of the limiting cap comprise projections overlapping the lugs of the second frame, the second frame and said legs having coplanar lower faces.

Additionally, another object of the invention is an anti-vibration system comprising an anti-vibration device as defined above and a receiving member onto which the limiting cap is fastened, the limiting cap clamping the second frame against the receiving member in the first direction. The receiving member in question can, in particular, be a portion of a vehicle body.

Another object of the invention is a method of manufacturing an anti-vibration system as defined above, comprising a preliminary mounting step in which the second frame of the anti-vibration support is snap-fitted onto the limiting cap, and a final mounting step in which the limiting cap is fastened onto the receiving member while clamping the second frame against said receiving member, in the first direction.

Finally, yet another object of the invention is an anti-vibration device comprising:
an anti-vibration support comprising first and second rigid frames connected together by an elastomeric body designed to support a load in the first direction,
and a limiting cap designed to fastened onto a receiving member, said limiting cap being designed to limit travel of the first frame, at least in the first direction and in a second direction perpendicular to the first direction, the second frame being connected to the limiting cap by at least one mechanical connection designed to rigidly connect said second frame to the limiting cap, and the limiting cap being designed to be fastened onto the receiving member while clamping the second frame against said receiving member, characterised in that the second frame is made of a plastic material (the temporary attachment of the second frame to the limiting cap can then be obtained by a simple operation, such as snapping, force-fitting, welding, gluing, etc. The final assembly between the limiting cap and the anti-vibration support is obtained only during mounting of the limiting cap on the receiving device, after which the second frame is clamped between the limiting cap and said receiving member).

Other characteristics and advantages of the invention will become apparent over the course of the following description of one of the embodiments thereof, which is given for non-limiting illustrative purposes, with reference to the appended drawings.

In the drawings:

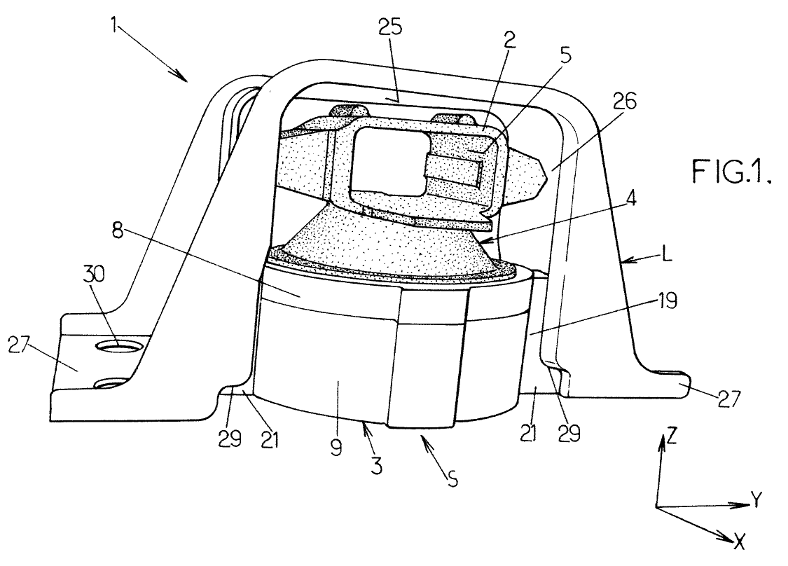

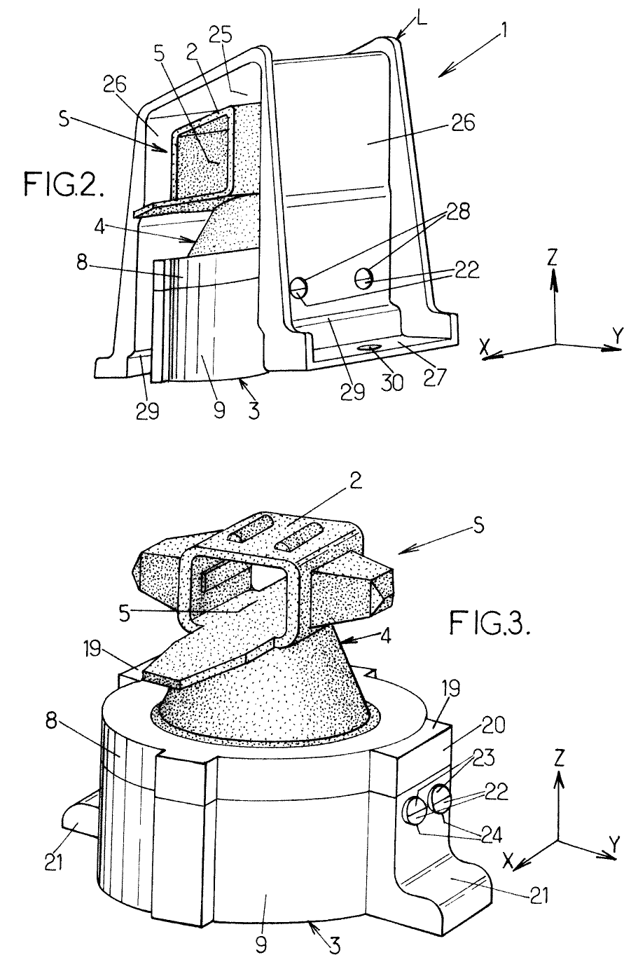

FIGS. 1 and 2 are perspective views of an anti-vibration device according to one embodiment of the invention, as seen in two opposite directions,

FIG. 3 is a perspective view of an anti-vibration support belonging to the anti-vibration device of FIGS. 1 and 2, as seen in the same direction as FIG. 2,

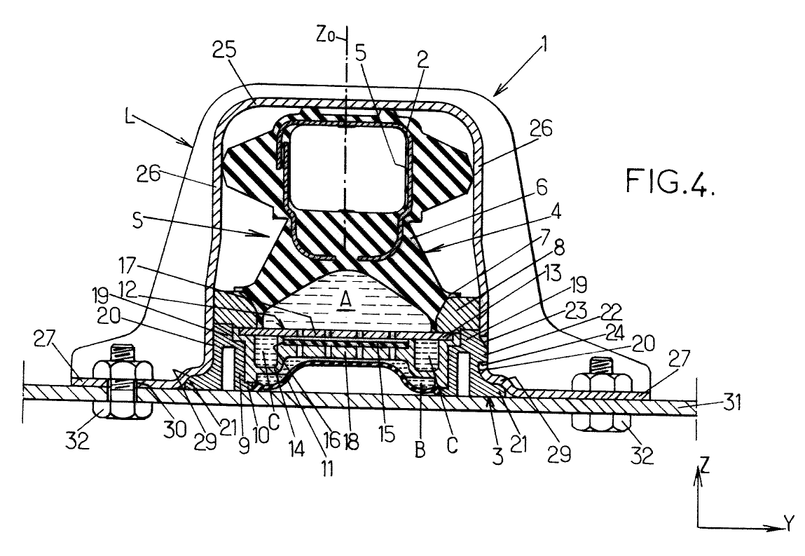

and FIG. 4 is a vertical cross-sectional view of an anti-vibration system comprising the anti-vibration device of FIGS. 1 and 2, which is mounted on a receiving member.

In the various figures, the same reference signs designate identical or similar elements.

As shown in FIGS. 1 and 2, the invention relates to an anti-vibration device 1 which includes:
on the one hand, an hydraulic anti-vibration support S comprising first and second rigid frames 2, 3, which are connected together by an elastomeric body 4 designed to support a load in a first, generally vertical direction Z,
and a limiting cap L designed to be fastened onto a receiving member 31, which will be described hereinbelow, this limiting cap being designed to limit travel of the first frame 2, at least in the first direction Z and in a second direction Y perpendicular to the first direction Z.

As shown in FIG. 4, the first frame 2, for example, can consist of a rolled sheet metal part, at the centre of which a recess 5 is defined, in a third direction X, which is perpendicular to the aforementioned first and second directions Z and Y. Via nesting, this recess 5, for example, can receive a connecting arm which is rigidly connected to a vehicle power-train unit.

In addition, the elastomeric body 4, for example, can have a bell-shape extending between:
a top which is over-moulded and adhered onto the first frame 2 (e.g., while forming protuberances which cooperate by abutting against the limiting cap L),
and an annular base 7, which is over-moulded and adhered onto the second frame 3.

The second frame 3 can, in particular, be made of a plastic material. This second frame, for example, can be made in two parts assembled together by welding or the like:
an upper ring 8 onto which the base 7 of the elastomeric body is over-moulded and adhered,
and a lower crown 9.

The lower end of the lower crown 9 comprises an annular inside rim 10 which is rigidly connected to a flexible elastomeric wall 11. The outer periphery of this flexible elastomeric wall 11, for example, can be over-moulded and adhered onto said inside rim 10. The flexible elastomeric wall 11 closes off the space left free inside the rim 10.

A rigid partition 12 is also interposed between the ring 8 and the crown 9 of the second frame, whereby this rigid partition 12 is made integral with the second frame 3. In the particular example shown in the drawings, the rigid partition 12, for example, can be moulded from a plastic material and consists of two parts:
one the one hand, an upper plate 13, and
on the other hand, a lower shell 14.

The rigid partition 12 serves as a separation between a working chamber A, which is defined by the elastomeric body 4, and a compensation chamber B, which is defined by the flexible elastomeric wall 11.

These two hydraulic chambers A and B are interconnected by way of a constricted passageway C in the shape of an arc of circle, which is defined by a peripheral groove made in the lower shell 14 of the partition 12. The constricted passageway C communicates with the working chamber A via an opening (not shown) made in the upper plate 13, and with the compensation chamber B, via an opening (not shown) made in the lower shell 14. The working chamber A and the compensation chamber B and the constricted passageway C thus comprise a leak-proof hydraulic system filled with liquid.

If need be, a decoupling valve 15, which, for example, consists of an elastomeric membrane, can likewise be arranged in a seat 16 made in the lower shell 14, the decoupling valve 15 being interposed with play between two grates 17, 18, which are made in the upper plate 13 and in the lower shell 14, respectively, and which communicate with the working chamber A and with the compensation chamber B, respectively.

The operation of the hydraulic anti-vibration support S is known per se and will therefore not be described in detail here:
the elastomeric body 4 is designed to take on the axial loads (in particular the weight of the propulsion unit) in the first direction Z,
the vibratory movements between the first and second frames 2, 3, at a high frequency and low amplitude (e.g., the vibrations due to the operation of the drive-train unit and having a frequency greater than 20 Hertz and an amplitude smaller than a few millimetres) are filtered by the decoupling valve 15,
the vibratory movements of low frequency (e.g., less than 20 Hertz) and of greater amplitude (e.g., greater than a few millimetres), which are generated, for example, by the rolling of the vehicle, give rise to transfers of liquid between the hydraulic chambers A, B, by way of the constricted passageway C.

The second frame 3, for example, can have an exterior shape which is substantially cylindrical, having a central axis Z0 which is parallel to the first direction Z, comprising two lateral protruding portions 19 (see FIGS. 1, 3 and 4), which are diametrically opposite, in the direction Y. These protruding portions 19 can each have one planar exterior face 20, the normal of which is oriented in the direction Y, and the lower portion of each of these protruding portions 19 is extended outwardly, in the direction Y, via a projection 21.

As shown in FIGS. 3 and 4, at least one of the protruding portions 19, in the upper portion thereof, further has at least one lug 22, which protrudes radially outward in the direction Y.

In the particular example shown in the drawings, one of the protruding portions 19 comprises two juxtaposed lugs 22, while the other protruding portion 19 does not comprise any lug 22. Each lug 22, for example, can have an upper face 23 angled downward and outwardly, and a lower face 24, which is substantially perpendicular to the direction Z.

As shown in FIGS. 1, 2 and 4, the limiting cap L, for example, can have an upper wall 25 overlapping the first frame 2 and two parallel lateral wings 26, which are arranged perpendicular to the second direction Y and which enclose the entire anti-vibration support S in said second direction Y, these two lateral wings being extended outwardly by two horizontal legs 27, which extend opposite to one another in the direction Y.

In the direction Z, the lateral wings 26 are nested on the outside faces 20 of protruding portions 19 and are provided with recesses 28 arranged in conjunction with the lugs 22 of the second frame, whereby said lugs become snapped on by penetrating into recesses 28, when the limiting cap L is nested onto the second frame 3 of the anti-vibration support.

In addition, the legs 27 of the limiting cap, at the junction thereof with the corresponding lateral wing 25, have a projection 29 which overlaps the corresponding projection 21 of the second frame. The lower faces of the second frame 33 and of feet 27 are arranged substantially in a single plane.

Legs 27 are further provided with attachment means, such as holes 30, which make it possible to attach the anti-vibration device to a receiving member 31, such as a portion of a vehicle body (in particular, a longitudinal body member), e.g., by means of nuts 32 or the like, as shown in FIG. 4.

The anti-vibration system just described can thus be assembled in two steps:
a preliminary and temporary mounting step in which the second frame 3 of the anti-vibration support S is snap-fitted onto the limiting cap L (after which these two parts remain assembled and can be easily stored and/or transported),
a final mounting step in which the limiting cap L is fastened onto the receiving member 31 while clamping the second frame 3 against said receiving member, in the direction Z, which then ensures a final rigid connection between the second frame 3, the limiting cap L and the receiving member 31.

1. An anti-vibration device comprising:
an anti-vibration support comprising first and second rigid frames connected together by an elastomeric body designed to support a load in the first direction,
and a limiting cap designed to fastened onto a receiving member, said limiting cap being designed to limit travel of the first frame, at least in the first direction and in a second direction perpendicular to the first direction, the second frame being connected to the limiting cap by at least one mechanical connection designed to rigidly connect said second frame to the limiting cap, wherein the second frame is snap-fitted onto the limiting cap in the first direction, and the limiting cap is designed to be fastened onto the receiving member while clamping the second frame against said receiving member.

2. The anti-vibration device of claim 1, wherein the anti-vibration support is hydraulic support which has a leak-proof hydraulic system and which is filled with liquid, comprising:
a working chamber defined by the elastomeric body,
a compensation chamber defined by a flexible elastomeric wall integral with the second frame,
and a constricted passageway interconnecting the working chamber and the compensation chamber.

3. The anti-vibration device as claimed in claim 1, wherein the second frame comprises at least one lateral lug inserted into a recess made in the limiting cap.

4. The anti-vibration device as claimed in claim 1, wherein the second frame is made of a plastic material.

5. The anti-vibration device as claimed in claim 1, wherein the limiting cap has an upside-down U-shape, comprising at least one upper wall overlapping the first frame and two lateral wings arranged on both sides of the anti-vibration support and snapped onto the second frame.

6. The anti-vibration device as claimed in claim 1, wherein the limiting cap further comprises two legs which extend the lateral wings opposite one another, said legs being provided with attachment means designed to be fastened onto said receiving member.

7. The anti-vibration device of claim 6, wherein the legs of the limiting cap overlap lugs belonging to the second frame.

8. The anti-vibration device of claim 7, wherein the legs of the limiting cap comprise projections overlapping the lugs of the second frame, the second frame and said legs having coplanar lower faces.

9. An anti-vibration system comprising an anti-vibration device as claimed in claim 1 and a receiving member onto which the limiting cap is fastened, the limiting cap clamping the second frame against the receiving member in the first direction.

10. The anti-vibration system of claim 9, wherein the receiving member is a portion of a vehicle body.

11. A method of manufacturing an anti-vibration system of claim 9, comprising:
a preliminary and temporary mounting step in which the second frame of the anti-vibration support is snap-fitted onto the limiting cap,
a final mounting step in which the limiting cap is fastened onto the receiving member while clamping the second frame against said receiving member, in the first direction.
